(19) United States
(12) Patent Application Publication
(10) Pub. No.: US 2017/0255292 A1
(43) Pub. Date: Sep. 7, 2017

(54) DETECTION DEVICE OF CAPACITIVE SCREEN

(71) Applicants: Shenzhen China Star Optoelectronics Technology Co. Ltd., Shenzhen, Guangdong (CN); Wuhan China Star Optoelectronics Technology Co. Ltd., Wuhan, Hubei (CN)

(72) Inventors: Jianxing XIE, Shenzhen, Guangdong (CN); Chang CAO, Shenzhen, Guangdong (CN); Yucheng TSAI, Shenzhen, Guangdong (CN)

(73) Assignees: Shenzhen China Star Optoelectronics Technology Co. Ltd., Shenzhen, Guangdong (CN); WUHAN CHINA STAR OPTOELECTRONICS TECHNOLOGY CO. LTD., Wuhan, Hubei (CN)

(21) Appl. No.: 14/905,097

(22) PCT Filed: Oct. 27, 2015
(86) PCT No.: PCT/CN2015/092922

§ 371 Date: Jan. 14, 2016

(30) Foreign Application Priority Data
Sep. 15, 2015 (CN) 201510587227.5

(51) Int. Cl. G06F 3/044; G06F 3/041

(52) U.S. Cl. CPC G06F 3/044; G06F 3/0416

(57) ABSTRACT

The present invention discloses a detection device of a capacitive screen. The capacitive screen comprises a plurality of common electrodes, and each of the common electrodes corresponds to a plurality of pixel electrodes, and the detection device comprises a signal transmitting module and a signal receiving module, wherein: the signal transmitting module is coupled to the common electrode, and employed to input a transmitting signal to the common electrode; the signal receiving module is coupled to the pixel electrode, and employed to collect a receiving signal, and calculates a capacitance between the common electrode and the corresponding pixel electrode according to the receiving signal, and determines whether the corresponding common electrode is disconnected or not according to the capacitance. By utilizing the present invention, the disconnected common electrode in the capacitive screen can be detected.

CROSS REFERENCE

This application claims the priority of Chinese Patent Application No. 201510587227.5, entitled “Detection device of capacitive screen”, filed on Sep. 15, 2015, the disclosure of which is incorporated herein by reference in its entirety.

### FIELD OF THE INVENTION

The present invention relates to an electronic technology field, and more particularly to a detection device of capacitive screen.

### BACKGROUND OF THE INVENTION

With the population of the electronic products, the capacitive touch panel (capacitive screen) is widely utilized in kinds of electronic products, such as the smart phone, the tablet and etc. The capacitive screens according to prior art comprises the added on capacitive screen, such as G+G (Glass+Glass), GF (Glass Film), GFF (Glass Film Film), OGS (One Glass Solution), and the embedded capacitive screen, such as On cell, In cell and etc. With the constant requirements of the user to the electronic product experience, the In cell with the most light and thin properties must become the capacitive screen of the mainstream in the future.

At present, one design solution of In cell capacitive screen is to divide the common electrode of the display into a block chess board structure as shown in FIG. 1. The independent block common electrode is formed by cutting one complete panel. Thus, the issue that the common electrode is disconnected during the cutting process may occur. It is a desperately urgent issue needed to be solved how to detect whether the common electrode is disconnected.

### SUMMARY OF THE INVENTION

The embodiment of the present invention provides a detection device of a capacitive screen, by which the disconnected common electrode in the capacitive screen can be detected.

The embodiment of the present invention provides a detection device of a capacitive screen, wherein the capacitive screen comprises a plurality of common electrodes, and each of the common electrodes corresponds to a plurality of pixel electrodes, and the detection device comprises a signal transmitting module and a signal receiving module, wherein:

the signal transmitting module is coupled to the common electrode, and employed to input a transmitting signal to the common electrode;

the signal receiving module is coupled to the pixel electrode, and employed to collect a receiving signal, and calculates a capacitance between the common electrode and the corresponding pixel electrode according to the receiving signal, and determines whether the corresponding common electrode is disconnected or not according to the capacitance.

In one possible implement, the plurality of common electrodes are aligned in a N*M array, and each of the pixel electrodes is acquired by intersecting one horizontal gate line and one vertical data line;

the signal transmitting module comprises N transmitting end, and each of the transmitting end is coupled to a column of the common electrodes, and the signal transmitting module is employed to input the transmitting signal to the common electrodes of respective columns;

the signal receiving module comprises N receiving ends, and each of the receiving end is coupled to data lines of a column the pixel electrode corresponded with the common electrodes, and the signal receiving module is employed to collect a receiving signal, and calculates a capacitance between the common electrode and the corresponding pixel electrode according to the receiving signal, and determines whether the corresponding common electrode is disconnected or not according to the capacitance.

In the second possible implement combining with the first possible implement, the detection device further comprises a signal controlling module, and the signal controlling module comprises M set of controlling ends, and each set of the controlling end is coupled to gates of a column of the pixel electrode corresponded with the common electrodes, and the signal controlling module is employed to sequentially input a switch signal to the gate lines of respective rows to sequentially open the gate lines of respective rows, wherein as the gate lines are opened, the pixel electrode on the gate line and the data line passing through the pixel electrode are conducted.

In the third possible implement combining with the second possible implement, the transmitting end comprises a first test pad for common, a first shorting bar and at least two traces, and the first test pad for common and the first shorting bar are short, and the first shorting bar is coupled to the same end of the at least two traces, and the at least two traces are coupled to a column of the common electrodes.

In the fourth possible implement combining with the third possible implement, the first shorting bar comprises a thin film transistor TFT.

In the fifth possible implement combining with the second possible implement, the signal control module is an array substrate row driving GOA controller.

In the sixth possible implement combining with the fifth possible implement, the switch signal is a Voltage of Gate High VGH/a Voltage of Gate Low VGL, or a clock.

In the seventh possible implement combining with the second possible implement, the receiving end comprises a second test pad for common and a second shorting bar, and the second test pad for common and the second shorting bar are coupled, and the second shorting bar is coupled to the same ends of data lines of a row of pixel electrodes corresponded with the common electrodes.

In the eighth possible implement combining with the seventh possible implement, the first shorting bar comprises a thin film transistor TFT.

In the ninth possible implement combining with the second possible implement, the plurality of pixel electrodes corresponded with all the common electrodes are short with one another.

As above, the detection device of the capacitive screen in the embodiment of the present invention comprises the signal transmitting module and the signal receiving module, wherein the signal transmitting module is employed to input the transmitting signal to the common electrode, and the signal receiving module is employed to collect the receiving signals from the pixel electrode, and calculates the capacitances between the respective common electrodes and the corresponding pixel electrodes according to the receiving signals, and determines whether the corresponding common electrodes are disconnected or not according to the capacitances. Thus, the disconnected common electrode in the capacitive screen can be detected.

### BRIEF DESCRIPTION OF THE DRAWINGS

In order to more clearly illustrate the embodiments of the present invention, the following figures will be described in the embodiments are briefly introduced. It is obvious that the drawings are merely some embodiments of the present invention, those of ordinary skill in this field can obtain other figures according to these figures without paying the premise.

FIG. 1 is a structure diagram of a common electrode provided by the embodiment of the present invention;

FIG. 2 is a structure diagram of a detection device of a capacitive screen provided by the embodiment of the present invention;

FIG. 3 is another structure diagram of a detection device of a capacitive screen provided by the embodiment of the present invention;

FIG. 4 is a flowchart of a detection method of a capacitive screen provided by the embodiment of the present invention.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

The capacitive screen in the embodiment of the present invention, which particularly refers to In cell capacitive screen is widely applied in the electronic products with portable touch control display, such as the smart phone, the tablet, the super notebook, the AV player, the mobile game terminal and the vehicle mobile terminal.

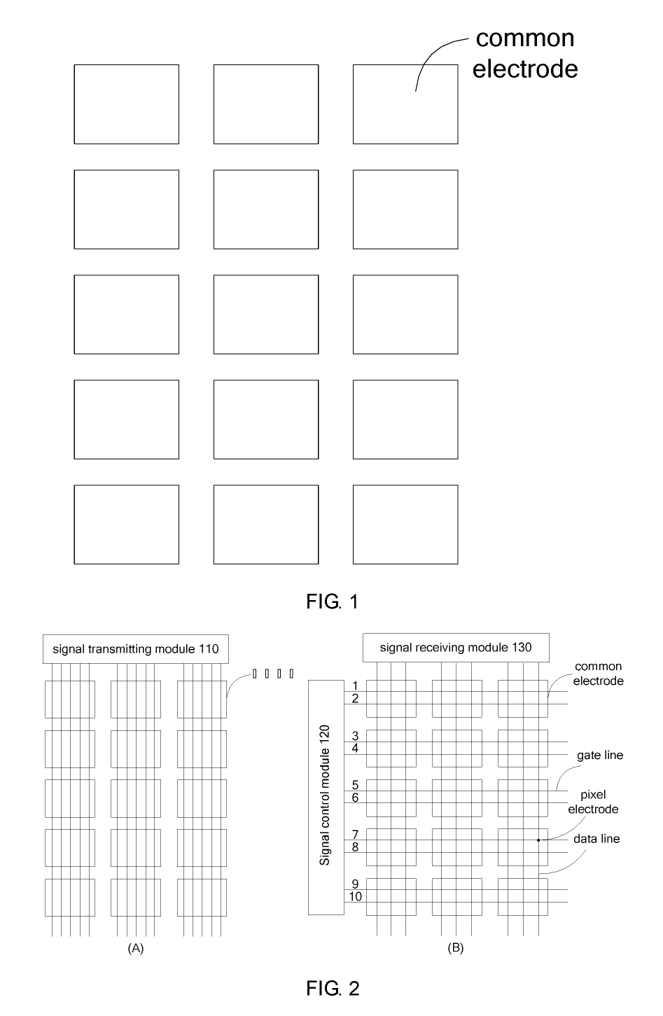

FIG. 1 is a structure diagram of a common electrode in the embodiment of the present invention. As shown in figure, the capacitive screen in the embodiment of the present invention comprises a plurality of common electrodes and the plurality of common electrodes are aligned in a N*M array. N, M are positive integers, and N represents the column, and M represents the row. For convenience, the present invention uses the 3*5 array (3 columns, 5 rows) shown in figure to be the illustration. Specifically, the array arrangement of the common electrodes is not limited thereto. It is understandable that each of the common electrodes corresponds to a plurality of pixel electrodes. Each pixel electrode of the pixel electrodes is acquired by intersecting one horizontal gate line and one vertical data line.

FIG. 2 is a structure diagram of a detection device of a capacitive screen in the embodiment of the present invention. As shown in figure, the detection device in the embodiment of the present invention comprises a signal transmitting module 110 and a signal receiving module 130, wherein:

the signal transmitting module 110 is coupled to the common electrode, and employed to input the transmitting signal to the common electrode.

the signal receiving module 130 is coupled to the pixel electrode, and employed to collect the receiving signals from the pixel electrode, and calculates the capacitances between the respective common electrodes and the corresponding pixel electrodes according to the receiving signals, and determines whether the corresponding common electrodes are disconnected or not according to the capacitances.

Specifically, the common electrode and the pixel electrode adjoin with each other but isolated. Because a certain capacitance exists between the two, and an electrical signal is inputted to the common electrode (i.e. the aforesaid transmitting signal), according to the property of the capacitor, the pixel electrode will correspondingly generates an electrical signal (i.e. the aforesaid receiving signal), according to these two electrical signals, the capacitance between the common electrode and the pixel electrode can be calculated. By determining whether the capacitance falls in the normal range, whether the common electrode is disconnected or not can be determined.

Specifically, as shown in FIG. 1, the common electrodes of the capacitive screen are aligned in the N*M array. For accurately determining one or more common electrodes which are disconnected in the array, the detection utilizing row, column scans can be employed. As being one selectable embodiment, the detection device in the embodiment of the present invention shown in FIG. 2 further comprises a signal control module 210, wherein:

Please refer to FIG. 2(A), the signal transmitting module 110 comprises N transmitting ends, and each of the transmitting ends is coupled to a column of the common electrodes, and the signal transmitting module 110 is employed to input the transmitting signal to the common electrodes of respective columns.

Specifically, an amount of the transmitting ends of the signal transmitting module 110 is equal to the column number N of the common electrodes. For convenience, the embodiment of the present invention uses 3 columns of the common electrodes for the illustration. Thus, the signal transmitting module 110 comprises 3 transmitting ends, and 3 transmitting ends are respectively coupled to 3 columns of common electrodes. Specifically in practical process, the signal transmitting module 110 respectively inputs transmitting signals to 3 columns of common electrodes through the 3 transmitting ends.

Please refer to FIG. 2(B), the signal controlling module 120 comprises M set of controlling ends, and each set of the controlling ends is coupled to gates of a column of the pixel electrodes corresponded with the common electrodes, and the signal controlling module 120 is employed to sequentially input a switch signal to the gate lines of respective rows to sequentially open the gate lines of respective rows, wherein as the gate lines are opened, the pixel electrode on the gate line and the data line passing through the pixel electrode are conducted.

For convenience, the embodiment of the present invention uses 10 horizontal gate lines and 9 vertical data lines for the illustration. 3 gate lines and 3 data lines pass through each of the common electrodes. Specifically, any two of the common electrodes, the gate lines and the data lines are mutually isolated. Because the pixel electrode is acquired by intersecting the gate line and the data line, each of the common electrodes corresponds to 6 pixel electrodes.

Specifically, the set amount of the control ends of the signal control module 120 is equal to the row number M. For convenience, the embodiment of the present invention uses 5 rows of common electrodes for the illustration. Therefore, the signal control module 120 comprises 5 sets of control ends. Each set of control ends is respectively coupled to the 2 gate lines of each row of the common electrodes. As shown in FIG. 2(B), the first set of control end is coupled to the first, second gate lines, and the second set of control ends is coupled to the third, fourth gate lines, . . . , the fifth set of control ends is coupled to the ninth, tenth gate lines. Specifically in practical process, the signal control module 120 sequentially inputs the switch signal to the gate lines of the 5 rows of common electrodes through the 5 sets of control ends (such as the order from the first set to the fifth set). It is understandable that if the voltage of the inputted switch signal reaches the preset threshold value, the gate line is opened, and the pixel electrode on the gate line and the data line passing through the pixel electrode are conducted. By sequentially opening the different gate lines, the different data lines can acquire the receiving signals on the pixel electrodes corresponded with the different common electrodes. For example, as the gate line of the common electrode of the third row is opened, the data line of the common electrode of the first row can acquire the receiving signal on the pixel electrode corresponded with the first common electrode of the third row, and the data line of the common electrode of the second row can acquire the receiving signal on the pixel electrode corresponded with the second common electrode of the third row, and so on.

Please refer to FIG. 2(B), the signal receiving module 130 comprises N receiving ends, and each receiving end is coupled to the data line of the pixel electrode corresponded with one column of the common electrodes, and the signal receiving module 130 is employed to collect the receiving signals from the data lines of respective columns, and calculates the capacitances between the respective common electrodes and the corresponding pixel electrodes according to the receiving signals, and determines whether the corresponding common electrodes are disconnected or not according to the capacitances.

Specifically, the amount of the receiving ends of the signal receiving module 130 is equal to the column number N of the common electrodes. Still, the aforesaid common electrode is illustrated. The signal control module 130 comprises 3 receiving ends. Each of the receiving ends is respectively coupled to 3 data lines of each column of the common electrodes. As shown in FIG. 2(B), the first receiving end is coupled to the first, second, third data lines, and the second receiving end is coupled to the fourth, fifth, sixth data lines, and the third receiving end is coupled to the seventh, eighth, ninth data lines. Specifically in practical process, the signal receiving module 130 collects the receiving signals from the data lines of the respective columns of the common electrodes, and a capacitance exists between each common electrode and the pixel electrode, and the signal receiving module 130 calculates the capacitances between the respective common electrodes and the corresponding pixel electrodes according to the receiving signals, and whether the capacitance is smaller than the preset normal value is determined. IF it is smaller than the preset normal value, the common electrode corresponding to the capacitance is determined to be disconnected. Because the gate lines are opened in order, and the data lines of collecting the receiving signals are well known. Therefore, the capacitances between all the common electrodes and the corresponding pixel electrodes can be calculated. Thus, the disconnected states of all the common electrodes can be determined. Selectably, for enlarging the test result, the capacitance between the common electrode and the corresponding pixel electrode can be increased. In the practical process, each of the common electrodes and the plurality of pixel electrodes corresponding thereto are short with one another, which is equivalent to that the plurality of pixel electrodes corresponding to the same common electrodes are considered to be a whole, and the capacitance between the whole and the corresponding common electrode is calculated. The capacitances between the plurality of pixel electrodes corresponding to the same common electrode and the common electrode do not have to be respectively calculated.

As above, the detection device of the capacitive screen in the embodiment of the present invention comprises the signal transmitting module and the signal receiving module, wherein the signal transmitting module is employed to input the transmitting signal to the common electrode, and the signal receiving module is employed to collect the receiving signals from the pixel electrode, and calculates the capacitances between the respective common electrodes and the corresponding pixel electrodes according to the receiving signals, and determines whether the corresponding common electrodes are disconnected or not according to the capacitances. Thus, the disconnected common electrode in the capacitive screen can be detected.

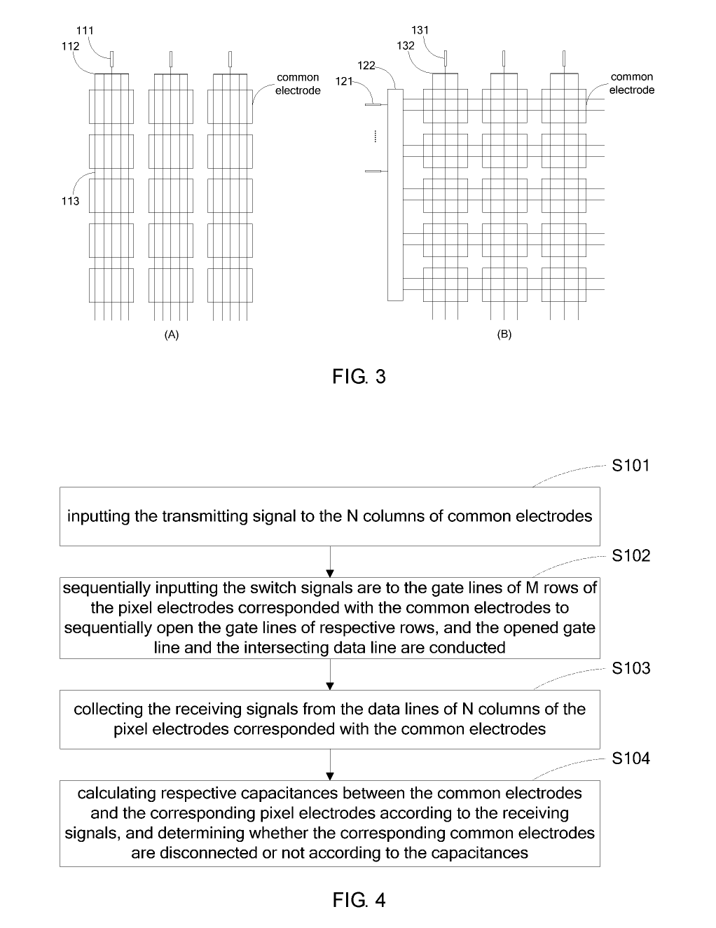

FIG. 3 is another structure diagram of a detection device of a capacitive screen in the embodiment of the present invention. The diagram is a detail in advance of the detection shown in FIG. 2. As shown in figure, in the detection device according to the embodiment of the present invention:

The transmitting end of the signal transmitting module 110 comprises a first test pad for common 111, a first shorting bar 112 and at least two wires 113. For convenience, the embodiment of the present invention uses 5 traces 113 for the illustration. The first test pad for common 111 is coupled to the first shorting bar 112, and the first shorting bar 112 is coupled to the same end of the 5 traces 113, and the 5 traces 113 are coupled to a column of the common electrodes. Selectably, the first shorting bar 112 also can be a trace or a TFT (Thin Film Transistor).

The signal control module 120 is a GOA (Gate driver ON Array) controller. Selectably, the switch signal outputted by the GOA controller is a VGH (Voltage of Gate High)/a VGL (Voltage of Gate Low), or a clock. It is understandable that the voltage value of VGH is larger than the preset threshold value, the gate line can be opened, and the voltage value of VGL is smaller than the preset threshold value, the gate line can be closed; the high voltage of the clock is larger than the preset threshold value, the gate line can be opened, and on the contrary, the voltage of the clock is smaller than the preset threshold value, the gate line can be closed. Therefore, with the switch signal of the aforesaid type in cooperation with the certain sequence, the signal control module 120 can achieve sequentially opening the gate lines of the common electrodes of respective rows. Furthermore, the control end of the signal control module 120 comprises at least one test pad for GOA 121 and a GOA circuit 122. The third test pad for GOA and the control GOA circuit 122 achieve outputting of the switch signal, together.

The receiving end of the signal receiving module 130 comprises a second test pad for data line 131 and a second shorting bar 132, and the second test pad for data line 131 and the second shorting bar 132 are coupled. The second shorting bar 132 is coupled to the same end of the data lines of the pixel electrode corresponded with a column of common electrodes. For example, one second shorting bar 132 is coupled to the same end of the 3 data lines. Selectably, the second shorting bar 132 also can be a trace or a TFT.

FIG. 4 is a flowchart of a detection method of a capacitive screen provided by the embodiment of the present invention. The detection method achieves the detection device of the capacitive screen in FIG. 1 to FIG. 3.As shown in figure, the detection method of the capacitive screen in this embodiment can comprise:

S101, inputting the transmitting signal to the N columns of common electrodes.

As shown in FIG. 1, the capacitive screen in the embodiment of the present invention comprises a plurality of common electrodes and the plurality of common electrodes are aligned in a N*M array. N, M are positive integers, and N represents the column, and M represents the row. For convenience, the present invention uses the 3*5 array (3 columns, 5 rows) shown in figure to be the illustration. Specifically, the array arrangement of the common electrodes is not limited thereto. It is understandable that each of common electrodes corresponds to a plurality of pixel electrodes, and each of the pixel electrodes is acquired by intersecting one horizontal gate line and one vertical data line. Specifically, the transmitting signals are respectively inputted to 3 columns of the common electrodes.

S102, the switch signals are sequentially inputted to the gate lines of M rows of the pixel electrodes corresponded with the common electrodes to sequentially open the gate lines of respective rows. The opened gate line and the intersecting data line are conducted.

For convenience, the embodiment of the present invention uses 10 horizontal gate lines and 9 vertical data lines for the illustration. 3 gate lines and 3 data lines pass through each of the common electrodes. Specifically, any two of the common electrodes, the gate lines and the data lines are mutually isolated. Because the pixel electrode is acquired by intersecting the gate line and the data line, each of the common electrodes corresponds to 6 pixel electrodes. The embodiment of the present invention uses 5 rows of common electrodes for the illustration. Therefore, 5 sets of control ends can be used. Each set of control ends is respectively coupled to the 2 gate lines of each row of the common electrodes. As shown in FIG. 2(B), the first set of control end is coupled to the first, second gate lines, and the second set of control ends is coupled to the third, fourth gate lines, . . . , the fifth set of control ends is coupled to the ninth, tenth gate lines.

Specifically, the switch signals are sequentially inputted to the gate lines of the 5 rows of common electrodes through the 5 sets of control ends (such as the order from the first set to the fifth set). It is understandable that if the voltage of the inputted switch signal reaches the preset threshold value, the gate line is opened, and the pixel electrode on the gate line and the data line passing through the pixel electrode are conducted. By sequentially opening the different gate lines, the different data lines can acquire the receiving signals on the pixel electrodes corresponded with the different common electrodes. For example, as the gate line of the common electrode of the third row is opened, the data line of the common electrode of the first row can acquire the receiving signal on the pixel electrode corresponded with the first common electrode of the third row, and the data line of second row can acquire the receiving signal on the pixel electrode corresponded with the second common electrode of the third row, and so on.

Selectably, the switch signal is outputted by the GOA (Gate driver ON Array) controller. Furthermore, the switch signal can be a VGH (Voltage of Gate High)/a VGL (Voltage of Gate Low), or a clock. It is understandable that the voltage value of VGH is larger than the preset threshold value, the gate line can be opened, and the voltage value of VGL is smaller than the preset threshold value, the gate line can be closed; the high voltage of the clock is larger than the preset threshold value, the gate line can be opened, and on the contrary, the voltage of the clock is smaller than the preset threshold value, the gate line can be closed. Therefore, with the switch signal of the aforesaid type in cooperation with the certain sequence, sequentially opening the gate lines of the common electrodes of respective rows can be achieved.

S103, collecting the receiving signals from the data lines of N columns of the pixel electrodes corresponded with the common electrodes.

Still, the aforesaid common electrode is illustrated. Specifically, it is to respectively collect the receiving signals from the data lines of the 3 columns of the common electrodes.

S104, calculating respective capacitances between the common electrodes and the corresponding pixel electrodes according to the receiving signals, and determining whether the corresponding common electrodes are disconnected or not according to the capacitances.

Specifically, the capacitances between the respective common electrodes and the corresponding pixel electrodes are calculated according to the receiving signals, and whether the capacitance is smaller than the preset normal value is determined. IF it is smaller than the preset normal value, the common electrode corresponding to the capacitance is determined to be disconnected. Because the gate lines are opened in order, and the data lines of collecting the receiving signals are well known. Therefore, the capacitances between all the common electrodes and the corresponding pixel electrodes can be calculated. Thus, the disconnected states of all the common electrodes can be determined. Selectably, for enlarging the test result, the capacitance between the common electrode and the corresponding pixel electrode can be increased. In the practical process, each of the common electrodes and the plurality of pixel electrodes corresponding thereto are short with one another, which is equivalent to that the plurality of pixel electrodes corresponding to the same common electrodes are considered to be a whole, and the capacitance between the whole and the corresponding common electrode is calculated.

As above, the detection device of the capacitive screen in the embodiment of the present invention comprises the signal transmitting module and the signal receiving module, wherein the signal transmitting module is employed to input the transmitting signal to the common electrode, and the signal receiving module is employed to collect the receiving signals from the pixel electrode, and calculates the capacitances between the respective common electrodes and the corresponding pixel electrodes according to the receiving signals, and determines whether the corresponding common electrodes are disconnected or not according to the capacitances. Thus, the disconnected common electrode in the capacitive screen can be detected.

The modules in the device according to the embodiment of the present invention can be merged, divided or deleted according to the actual requirements.

The module in the embodiment of the present invention can be realized with general integrated circuit, such as a CPU (Central Processing Unit) or with an ASIC (Application Specific Integrated Circuit).

It is understandable in practical to the person who is skilled in the art that all or portion of the processes in the method according to the aforesaid embodiment can be accomplished with the computer program to instruct the related hardwares. The program can be stored in a readable storage medium if the computer. As the program is executed, the processes of the embodiments in the aforesaid respective methods can be included. The storage medium can be a hardisk, an optical disc, a Read-Only Memory (ROM) or a Random Access Memory (RAM).

Above are embodiments of the present invention, which does not limit the scope of the present invention. Any equivalent amendments within the spirit and principles of the embodiment described above should be covered by the protected scope of the invention.

What is claimed is:

1. A detection device of a capacitive screen, wherein the capacitive screen comprises a plurality of common electrodes, and each of the common electrodes corresponds to a plurality of pixel electrodes, and the detection device comprises a signal transmitting module and a signal receiving module, wherein:
the signal transmitting module is coupled to the common electrode, and employed to input a transmitting signal to the common electrode;
the signal receiving module is coupled to the pixel electrode, and employed to collect a receiving signal, and calculates a capacitance between the common electrode and the corresponding pixel electrode according to the receiving signal, and determines whether the corresponding common electrode is disconnected or not according to the capacitance.

2. The detection device of the capacitive screen according to claim 1, wherein the plurality of common electrodes are aligned in a N*M array, and each of the pixel electrodes is acquired by intersecting one horizontal gate line and one vertical data line;
the signal transmitting module comprises N transmitting end, and each of the transmitting end is coupled to a column of the common electrodes, and the signal transmitting module is employed to input the transmitting signal to the common electrodes of respective columns;
the signal receiving module comprises N receiving ends, and each of the receiving end is coupled to data lines of a column the pixel electrode corresponded with the common electrodes, and the signal receiving module is employed to collect a receiving signal, and calculates a capacitance between the common electrode and the corresponding pixel electrode according to the receiving signal, and determines whether the corresponding common electrode is disconnected or not according to the capacitance.

3. The detection device of the capacitive screen according to claim 2, wherein the detection device further comprises a signal controlling module, and the signal controlling module comprises M set of controlling ends, and each set of the controlling end is coupled to gates of a column of the pixel electrode corresponded with the common electrodes, and the signal controlling module is employed to sequentially input a switch signal to the gate lines of respective rows to sequentially open the gate lines of respective rows, wherein as the gate lines are opened, the pixel electrode on the gate line and the data line passing through the pixel electrode are conducted.

4. The detection device of the capacitive screen according to claim 3, wherein the transmitting end comprises a first test pad for common, a first shorting bar and at least two traces, and the first test pad for common and the first shorting bar are short, and the first shorting bar is coupled to the same end of the at least two traces, and the at least two traces are coupled to a column of the common electrodes.

5. The detection device of the capacitive screen according to claim 4, wherein the first shorting bar comprises a thin film transistor TFT.

6. The detection device of the capacitive screen according to claim 3, wherein the signal control module is an array substrate row driving GOA controller.

7. The detection device of the capacitive screen according to claim 6, wherein the switch signal is a Voltage of Gate High VGH/a Voltage of Gate Low VGL, or a clock.

8. The detection device of the capacitive screen according to claim 3, wherein the receiving end comprises a second test pad for common and a second shorting bar, and the second test pad for common and the second shorting bar are coupled, and the second shorting bar is coupled to the same ends of data lines of a row of pixel electrodes corresponded with the common electrodes.

9. The detection device of the capacitive screen according to claim 8, wherein the second shorting bar comprises a thin film transistor TFT.

10. The detection device of the capacitive screen according to claim 3, wherein the plurality of pixel electrodes corresponded with all the common electrodes are short with one another.
